(19) United States
(12) Patent Application Publication
(10) Pub. No.: US 2020/0119408 A1
(43) Pub. Date: Apr. 16, 2020

(54) BATTERY MANAGEMENT APPARATUS AND METHOD

(71) Applicant: Samsung Electronics Co., Ltd., Suwon-si (KR)

(72) Inventors: YOUNGJAE KIM, Seoul (KR); JINYONG JEON, Seoul (KR)

(73) Assignee: Samsung Electronics Co., Ltd., Suwon-si (KR)

(21) Appl. No.: 16/365,752

(22) Filed: Mar. 27, 2019

(30) Foreign Application Priority Data
Oct. 10, 2018 (KR) 10-2018-0120574

(51) Int. Cl. H01M 10/42; H01M 10/48; H01M 2/20

(52) U.S. Cl. CPC H01M 10/425; H01M 10/486; H01M 2010/4271; H01M 2/202; H01M 10/482

(57) ABSTRACT

A bus bar apparatus includes a bus bar including: a conductor configured to electrically connect battery cells included in a battery pack; and a controller configured to manage the battery pack based on information obtained from the conductor, wherein the conductor and the controller are implemented on a same substrate.

### CROSS-REFERENCE TO RELATED APPLICATIONS

This application claims the benefit under 35 USC § 119(a) of Korean Patent Application No. 10-2018-0120574 filed on Oct. 10, 2018 in the Korean Intellectual Property Office, the entire disclosure of which is incorporated herein by reference for all purposes.

### BACKGROUND

### 1. Field

The following description relates to a battery management apparatus and method.

### 2. Description of Related Art

In general, to produce a battery pack, all cells included in the battery pack may be connected in series by applying a bus bar between the cells, and two wires may be used for each cell to measure a voltage of the cell. In addition, the typical battery pack uses separate wires for temperature measurement and communication.

A method of removing wires for communication between a slave battery management system (BMS) and a master BMS of each module by applying wireless communication to a battery pack and battery modules has yet to be properly developed. Further, a cell voltage measurement device using a flexible printed circuit board (FPCB) is used to replace existing covered wires.

A method of maximizing an energy density of the battery packet by minimizing the total weight of the wires, bus bars, battery modules, and BMS applied to the battery pack has yet to be properly developed.

That is, when battery modules and a battery pack are constructed as in the existing technology, a large number of wires and bus bars are needed, and thus there is limitation in improving an energy density of the battery pack, and the assembly complexity of the battery modules and the battery pack is increased, which leads to a significant increase in cost for production.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a bus bar apparatus includes a bus bar including: a conductor configured to electrically connect battery cells included in a battery pack; and a controller configured to manage the battery pack based on information obtained from the conductor, wherein the conductor and the controller are implemented on a same substrate.

The conductor may be configured to electrically connect a positive electrode of a first battery cell of the battery cells and a negative electrode of a second battery cell of the battery cells adjacent to the first battery cell.

The controller may include a converter configured to measure a voltage applied to either one or both ends of the conductor.

The controller further may include a temperature sensor configured to measure either one or both of a temperature of the conductor and temperatures of the battery cells.

The controller may be configured to estimate a current of the battery pack based on the voltage and the either one or both of the temperature of the conductor and the temperatures of the battery cells.

The information may indicate any one or any combination of any two or more of the estimated current, the measured voltage, and the either one or both of the temperature of the conductor and the temperatures of the battery cells.

The controller may include a communicator configured to exchange the information with an adjacent bus bar.

The communicator may be configured to exchange the information through either one or both of wired and wireless communication.

The communicator may be configured to exchange the information with the adjacent bus bar by transmitting the information to, and by receiving other information from, a communicator of the adjacent bus bar, and the other information may be information obtained from a conductor of the adjacent bus bar.

The substrate may include a printed circuit board (PCB).

The controller may be configured to manage the battery pack by determining either one or both of a state of charge and a state of health of one or more of the battery cells, based on either one or both of the information obtained from the conductor and information of one or more other battery cells received from an adjacent bus bar.

The bus bar apparatus may be a battery management apparatus and further comprises another bus bar comprising: another conductor configured to electrically connect battery cells included in the battery pack; and another controller configured to manage the battery pack based on information obtained from the other conductor, wherein the other conductor and the other controller are implemented on another same substrate.

In another general aspect, a battery management apparatus, includes: a first bus bar and a second bus bar, each comprising: a conductor configured to electrically connect battery cells included in a battery pack; and a controller implemented on a substrate on which the conductor is disposed, the controller being configured to manage the battery pack based on information related to the battery cells obtained from the conductor.

The conductor of the first bus bar may be configured to electrically connect a positive electrode of a first battery cell of the battery cells and a negative electrode of a second battery cell of the battery cell adjacent to the first battery cell, and the conductor of the second bus bar may be configured to electrically connect a positive electrode of the second battery cell and a negative electrode of a third battery cell of the battery cell adjacent to the second battery cell.

The controller of the first bus bar and the controller of the second bus bar may each include a converter configured to measure a voltage applied to either one or both ends of the respective conductor.

The controller of the first bus bar and the controller of the second bus bar may each further include a temperature sensor configured to measure either one or both of a temperature of the respective conductor and temperatures of the respective battery cells.

The controller of the first bus bar and the controller of the second bus bar may each be configured to estimate a current of the battery pack based on the voltage and the either one or both of the temperature of the respective conductor and the temperatures of the respective battery cells.

The controller of the first bus bar may include a communicator configured to exchange the information of the first bus bar with the second bus bar, and the controller of the second bus bar may include a communicator configured to exchange the information of the second bus bar with the first bus bar.

The communicator of the first bus bar and the communicator of the second bus bar may each be configured to exchange the respective information of the first or the second bus bar through either one or both of wired and wireless communication.

The substrate of either one or both of the first bus bar and the second bus bar may include a printed circuit board (PCB).

In another general aspect, there is a method of manufacturing a battery management apparatus, the method including: forming a conductor on a substrate to electrically connect battery cells included in a battery pack; and connecting a controller, to the conductor on the substrate, configured to manage the battery pack by obtaining information from the conductor.

The connecting may include: connecting a converter of the controller to the conductor to measure a voltage applied to the conductor; and connecting a temperature sensor of the controller to the conductor to measure either one or both of a temperature of the conductor and temperatures of the battery cells.

The connecting of the controller to the conductor further may include: connecting a communicator of the controller to the converter to exchange the information with an adjacent bus bar through either one or both of wired and wireless communication.

The method further may include: connecting the conductor to the battery cells to electrically connect a positive electrode of a first battery cell of the battery cells and a negative electrode of a second battery cell of the battery cells adjacent to the first battery cell.

Other features and aspects will be apparent from the following detailed description, the drawings, and the claims.

### BRIEF DESCRIPTION OF THE DRAWINGS

FIG. 1 illustrates an example of a bus bar.

FIG. 2 illustrates an example of a controller.

FIG. 3A illustrates an example of implementing a bus bar.

FIG. 3B illustrates an example of implementing a bus bar.

FIG. 3C illustrates an example of implementing a bus bar.

FIG. 4 illustrates an example of measuring a current of a battery pack by a bus bar.

FIG. 5 illustrates an example of connections between battery cells and bus bars.

FIG. 6A illustrates an example of a view of connections between battery cells and bus bars.

FIG. 6B illustrates an example of a view of connections between battery cells and bus bars.

FIG. 7 illustrates an example of connections between battery cells and bus bars.

FIG. 8A illustrates an example of a view of connections between battery cells and bus bars.

FIG. 8B illustrates an example of a view of connections between battery cells and bus bars.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

Unless otherwise defined, all terms including technical and scientific terms used herein have the same meaning as commonly understood by one of ordinary skill in the art to which this disclosure pertains and in the context of the disclosure of the present application. It will be further understood that terms, such as those defined in commonly-used dictionaries, should be interpreted as having a meaning that is consistent with their meaning in the context of the relevant art and the disclosure of the present application, and such terms are not be interpreted in an idealized or overly formal sense unless expressly so defined herein.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

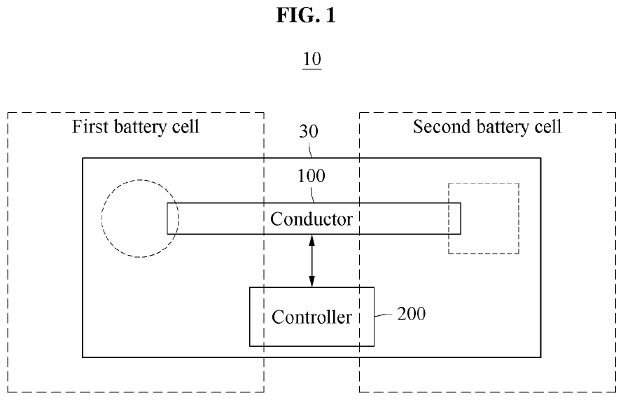

FIG. 1 illustrates an example of a bus bar.

Referring to FIG. 1, a battery stores and converts chemical energy into electricity and generates a current to supply power to an electrical device. The battery is implemented in a form of a battery pack. The battery pack may include one or more battery modules, and a battery module may include one or more battery cells.

A battery cell may be implemented in various shapes. For example, the battery cell may be implemented in a square shape. An external portion of the battery cell includes a positive electrode terminal and a negative electrode terminal for electrical connections to a preceding cell and a subsequent cell, for example, and may include a safety vent through which gas is discharged, e.g., when a cell is abnormal. Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

A bus bar 10 connects battery cells or battery modules. For example, the bus bar 10 may connect the battery cells or the battery modules in series. A current flows between the battery cells or the battery modules through the bus bar 10. For example, the bus bar 10 may electrically connect two cells by connecting at least one battery cell in series, and a high current flows through the bus bar 10.

The bus bar 10 monitors a battery. The bus bar 10 collects information related to the battery cells. For example, the information includes electrical information related to the battery cells.

The bus bar 10 estimates states of the battery cells, the battery modules, and/or the battery pack based on a current flowing through the bus bar 10, a voltage applied to the bus bar 10, and/or a temperature of the bus bar 10.

The states of the battery cells include a state of charging (SOC) of the battery and/or a state of health (SOH) of the battery. The bus bar 10 may manage the battery cells, the battery modules, and/or the battery pack based on the estimated states.

The bus bar 10 includes a conductor 100 and a controller 200. The conductor 100 and the controller 200 may be implemented on the same substrate 30.

The substrate 30 includes at least one electronic component and at least one wire. The least one electronic component may include a resistor, a condenser, and/or an integrated circuit. For example, the substrate 30 may include a printed circuit board (PCB).

The conductor 100 electrically connects the battery cells included in the battery pack. The conductor 100 allows a flow of an electrical current in one or more directions.

For example, the conductor 100 may electrically connect a positive electrode of a first battery cell and a negative electrode of a second battery cell adjacent to the first battery cell, the first battery cell and the second battery cell being included in the battery pack. Conversely, the conductor 100 may electrically connect a negative electrode of the first battery cell and a positive electrode of the second battery cell adjacent to the first battery cell, the first battery cell and the second battery cell being included in the battery pack.

The conductor 100 includes a material having electrical conductivity. For example, the conductor 100 includes metal, such as aluminum and/or copper, as non-limiting examples.

The controller 200 manages the battery pack based on information obtained from the conductor 100. The information obtained from the conductor 100 includes information related to the conductor 100 and/or information related to the battery cells obtained from the conductor 100.

The information obtained from the conductor 100 includes physical information related to the conductor 100 and the battery cells. For example, the information obtained from the conductor 100 includes a current flowing through the conductor 100, a voltage of both ends of the conductor 100, and/or a temperature of the conductor 100.

A battery management apparatus manages the battery cells, the battery modules, and/or the battery pack using a plurality of bus bars 10. Here, it is noted that the bus bar 10 may be considered a battery management apparatus.

Each of the plurality of bus bars 10 included in the battery management apparatus includes the conductor 100 and the controller 200. The battery management apparatus includes a plurality of conductors 100 to electrically connect the battery cells included in the battery pack.

That is, a portion of the battery cells of the battery pack may be connected by only the conductor 100 which electrically connects battery cells, and a remaining portion of the battery cells of the battery pack may be connected using the bus bar 10 including the conductor 100 connected to the controller 200.

The controller 200 is implemented on the substrate 30 on which at least one of the plurality of conductors 100 is implemented, and manages the battery pack based on information related to the battery cells obtained from the at least one conductor 100.

The battery management apparatus may manage the battery pack using the plurality of bus bars 10. The bus bars 10 are connected between all the battery cells included in the battery pack or between only a portion of the battery cells, i.e., not all of the battery cells.

The bus bar 10 connects a set of a predetermined number of cells. For example, the bus bar 10 connects a set of two battery cells and another set of two battery cells adjacent thereto. A set of battery cells includes at least two battery cells.

The battery management apparatus may manage the battery on a cell basis (e.g., a cell-by-cell basis) by obtaining accurate information related to the battery cells from the plurality of bus bars 10. By exchanging the information related to the battery cells using communicators included in the plurality of bus bars 10, the battery management apparatus may efficiently managing the battery pack.

By integrating a function to manage the battery and a function to electrically connect the battery cells through the bus bar 10, the number of wires to be used to monitor or sense the information related to the battery cells is reduced compared to a typical approach of separate components for a function to manage the battery and a function to electrically connect the battery cells. By such resulting reduced number of wires, the herein example of manufacturing the battery modules and the battery pack may be simplified and improved over said typical approach, for example.

The bus bar 10 may perform both the function to electrically connect the battery cells and a function to measure the information related to the battery cells together by utilizing a substrate such as a PCB, thereby simultaneously providing a path of the current between the battery cells and performing the function to monitor the battery.

By integrating sensing wires for measuring the states of the battery cells and wires used for a battery management system (BMS) using the bus bar 10, the battery pack may be optimized.

By applying the bus bar 10, a battery pack with high energy density may be manufactured, and the process of manufacturing the battery pack and the battery management apparatus may be simplified. Further, through this simplified manufacturing process, unit prices of the battery pack and the battery management apparatus may be reduced.

By applying the BMS on a cell basis using the bus bar 10, a design flexibility of the battery pack may increase. For example, examples include the battery pack having various configurations on a module basis and/or on a cell basis.

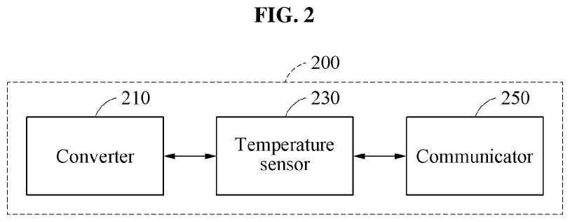

FIG. 2 illustrates an example of a controller (e.g., the controller of FIG. 1).

Referring to FIG. 2, the controller 200 includes a converter 210, a temperature sensor 230, and a communicator 250, for example.

The converter 210 measures a voltage applied to both ends of the conductor 100. The converter 210 includes an analog-to-digital (A/D) converter.

The temperature sensor 230 measures a temperature of the conductor 100 and/or temperatures of the battery cells.

The controller 200 estimates a current of the battery pack based on the voltage applied to both ends of the conductor 100, the temperature of the conductor 100, and/or the temperatures of the battery cells.

The communicator 250 exchanges the information obtained from the conductor 100 with an adjacent bus bar. For example, the communicator 250 may transmit the information to a communicator 250 of the adjacent bus bar and also may receive similarly-generated information from the communicator 250 of the adjacent bus bar. In an example, the information indicates any one or any combination of any two or more of the estimated current, the measured voltage, and the either one or both of the temperature of the conductor and the temperatures of the battery cells. The communicator 250 exchanges the information through wired and/or wireless communication. For example, the communicator 250 exchanges the information with an adjacent bus bar 10 through near field communication (NFC), Bluetooth, and/or infrared communication, as non-limiting examples.

The bus bar 10 may be manufactured by forming a conductor electrically connecting the battery cells included in the battery pack on the substrate 30 to electrically connect the battery cells. Further, the bus bar 10 may be manufactured by connecting the controller 200 to the conductor 100 on the substrate 30 to manage the battery pack by obtaining information from the conductor 100. In an example, the controller 200 is configured to manage the battery pack by determining either one or both of a state of charge and a state of health of one or more of the battery cells, based on either one or both of the information obtained from the conductor and information of one or more other battery cells received from an adjacent bus bar.

The conductor 100 is connected to the communicator 250 and/or the converter 210 to exchange the information obtained from the conductor 100 with the adjacent bus bar 10 through wired or wireless communication.

The bus bar 10 may be manufactured so that the substrate 30 is configured to connect to the battery pack such that a positive electrode of a first battery cell is electrically connected to a negative electrode of a second battery cell adjacent to the first battery cell through the conductor 100, the first battery cell and the second battery cell being included in the battery pack.

The bus bar 10 may perform both a function to manage the battery and a function to electrically connect the battery cells by implementing the conductor 100 and the controller 200 on the same substrate 30, thereby the number of wires or cables needed for monitoring electrical information of the battery cells may be minimized, thereby a process of manufacturing both the bus bar 10 and the battery management system may be advantageously simplified and/or a cost of the manufacturing may be reduced.

For example, a typical BMS may use 98 wires to sense voltages of the battery cells, whereas the bus bar 10 may have a reduced number of wires of 49 and may minimize the length of wires.

Further, in an example, an existing BMS may use a number of wires for sensing temperature, whereas the bus bar 10 does may not include or require wires for sensing temperatures.

In addition, by simplifying a process of manufacturing the battery pack and the battery modules using the bus bar 10, the maintenance of the battery may be performed efficiently, and the productivity may thus improve or a typical battery management system which may require much more wiring, for example.

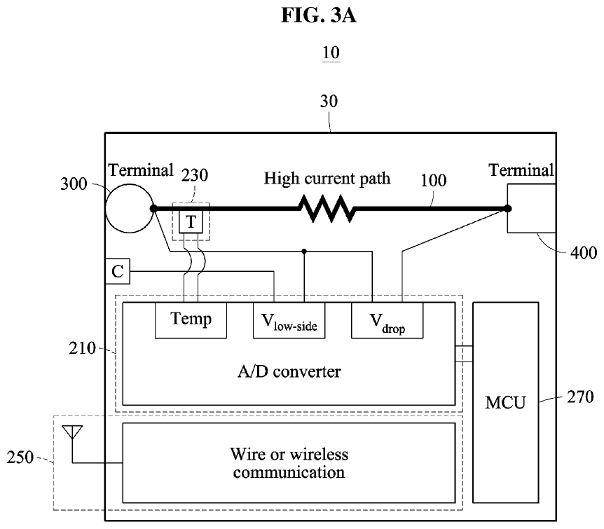

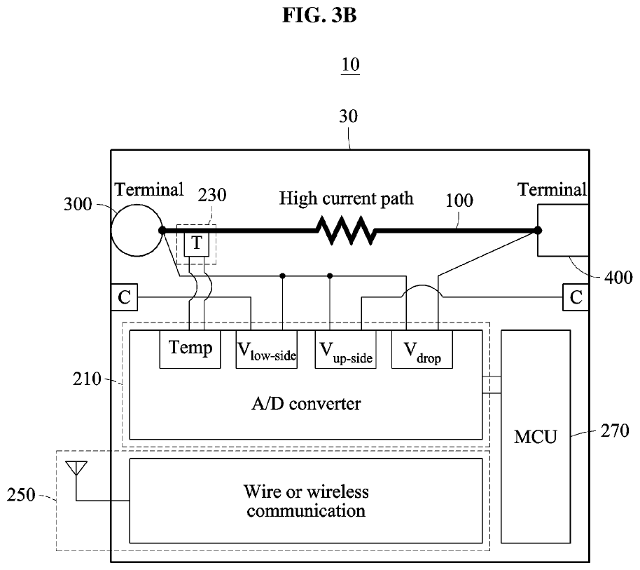

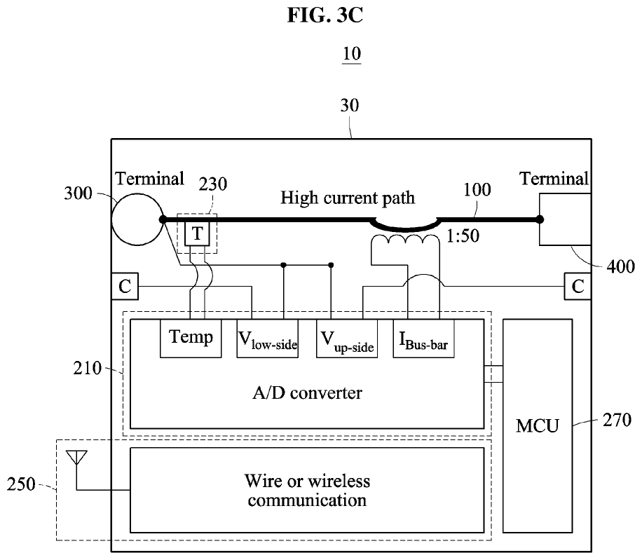

Hereinafter, an operation of the bus bar 10 will be described with reference to FIGS. 3A through 3C.

FIG. 3A illustrates an example of implementing a bus bar (e.g., the bus bar of FIG. 1), FIG. 3B illustrates an example of implementing a bus bar (e.g., the bus bar of FIG. 1), and FIG. 3C illustrates an example of implementing a bus bar (e.g., the bus bar of FIG. 1).

Referring to FIGS. 3A through 3C, the bus bar 10 includes the conductor 100 and the controller 200 implemented on a single substrate 30. The conductor 100 is used as a path of a current flowing between the battery cells.

End portions of the conductor 100 are connected to terminals 300 and 400. The terminals 300 and 400 are connected to different battery cells. For example, the terminal 300 is connected to the positive electrode of the first battery cell included in the battery pack, and the terminal 400 is connected to the negative electrode of the second battery cell included in the battery pack.

The conductor 100 is formed of a material having high conductivity so as to allow a flow of high current between the battery cells. The conductor 100 connects the two terminals 300 and 400 in various shapes. For example, the conductor 100 has a shape of a zigzag or a curved line.

The controller 200 includes the converter 210, the temperature sensor 230, and the communicator 250, and selectively includes a micro control unit (MCU) 270.

The converter 210 is implemented as an A/D converter. The converter 210 obtains information related to the battery cells from the conductor 100.

The converter 210 measures a voltage applied to the conductor 100. The converter 210 measures a temperature of the conductor 100 and/or temperatures of the battery cells through the temperature sensor 230. The converter 210 outputs the information obtained from the conductor 100 to the communicator 250 and the MCU 270.

In the example of FIG. 3C, the converter 210 measures the current flowing in the conductor 100 by forming the conductor 100 and a transformer.

The temperature sensor 230 measures the temperature of the conductor 100 and/or the temperatures of the battery cells. The temperature sensor 230 measures the temperature of the conductor 100 while contacting or not contacting the conductor 100 and the battery cells.

The communicator 250 exchanges information related to the battery cells with an adjacent bus bar 10. Being adjacent refers to being positioned within a predetermined distance. For example, the adjacent bus bar 10 refers to a bus bar 10 connecting a battery cell connected to a preceding bus bar 10 to a subsequent battery cell. In another example, the adjacent bus bar 10 refers to, when battery cells are disposed sequentially, a bus bar 10 connecting battery cells of a subsequent row.

The communicator 250 exchanges the information related to the battery cells through wired and/or wireless communication. In an embodiment wherein the communicator 250 exchanges the information related to the battery cells through wireless communication, the number of wires used for the battery pack is significantly decreased.

The controller 200 calculates a current of the battery pack through the MCU 270. The controller 200 calculates the current of the battery pack based on the voltage measured by the converter 210 and/or the temperature or temperatures measured by the temperature sensor 230.

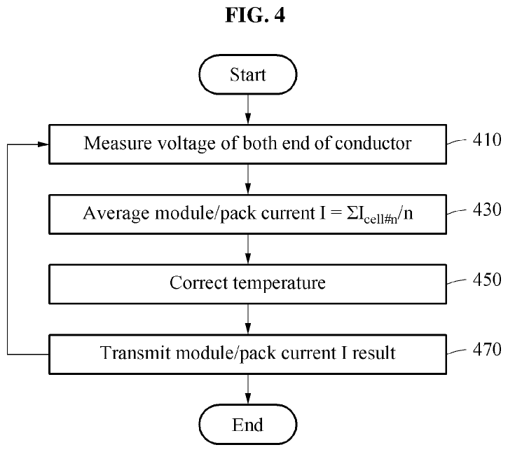

FIG. 4 illustrates an example of measuring a current of a battery pack by a bus bar (e.g., the bus bar of FIG. 1).

Referring to FIG. 4, the controller 200 estimates the current of the battery pack based on the voltage and/or the temperature measured from the conductor 100.

First, in operation 410, the converter 210 measures a voltage of both ends of the conductor 100. In operation 430, the controller 200 or the MCU 270 calculates an average module/pack current I. The controller 200 calculates the average module/pack current (e.g., the average battery module current of a battery pack, wherein the battery pack includes a plurality of battery modules that each include at least one bus bar 10 and at least two battery cells) based on Equation 1, for example.

$$I = \sum \frac{{I}_{cell \# n}}{N} \qquad Equation 1$$

In Equation 1, N denotes the total number of conductors 100, and I_{cell#n} denotes a current flowing through an n-th conductor 100, which may be calculated based on Equation 2, for example.

$${I}_{cell \# n} = \frac{{V}_{drop \# n}}{{R}_{\# n}} \qquad Equation 2$$

In Equation 2, V_{drop#n} denotes a voltage applied to both ends of the conductor 100 measured at the n-th conductor 100, and R_{#n} denotes a resistance of the n-th conductor 100.

In operation 450, the controller 200 corrects the calculated average module/pack current using the temperature measured through the temperature sensor 230. Through this, the controller 200 obtains the corrected module/pack current I. In operation 470, the controller 200 transmits the corrected module/pack current I to another bus bar 10 or battery management apparatus.

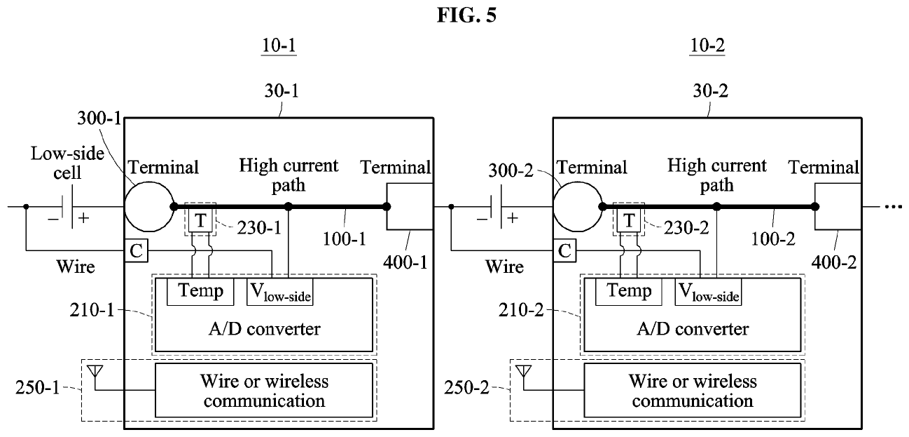

FIG. 5 illustrates an example of connections between battery cells and bus bars (e.g., including the bus bar 10 of FIG. 1).

Referring to FIG. 5, bus bara first bust-bar 10-1 and a second bus bar 10-2 are connected between all cells included in the battery pack or between only a portion of the cells. Each of bus bars 10-1 and 10-2 includes the conductor 100 and the controller 200.

A conductor 100-1 of the first bus bar 10-1 is connected to two terminals 300-1 and 400-1, and a conductor 100-2 of the second bus bar 10-2 is connected to two terminals 300-2 and 400-2. In this example, the terminal 300-1 is connected to the positive electrode of the first battery cell, and the terminal 400-1 is connected to the negative electrode of the second battery cell. Similarly, the terminal 300-2 is connected to the positive electrode of the second battery cell, and the terminal 400-2 is connected to a negative electrode of a third battery cell.

The circular terminal 300-1 connected to a left end of the conductor 100-1 is connected to a positive electrode of a battery cell, and the square terminal 400-1 connected to a right end of the conductor 100-1 is connected to a negative electrode of a battery cell. However, in another example, the terminals 300-1 and 400-1 may be connected reversely.

The first bus bar 10-1 includes a converter 210-1, a temperature sensor 230-1, and a communicator 250-1 on a substrate 30-1, and the second bus bar 10-2 includes a converter 210-2, a temperature sensor 230-2, and a communicator 250-2 on a substrate 30-2.

The converter 210-1 obtains information related to the conductor 100-1 or the battery cells by measuring a voltage applied to the conductor 100-1 and receiving a temperature of the conductor 100-1 through the temperature sensor 230-1. The information obtained by the converter 210-1 includes information related to the first battery cell and the second battery cell.

The converter 210-1 outputs the information related to the conductor 100-1 or the battery cells to the communicator 250-1. The communicator 250-1 exchanges the information with the communicator 250-2 of the second bus bar 10-2.

An operation of the second bus bar 10-2 is similar or the same as the operation of the first bus bar 10-1.

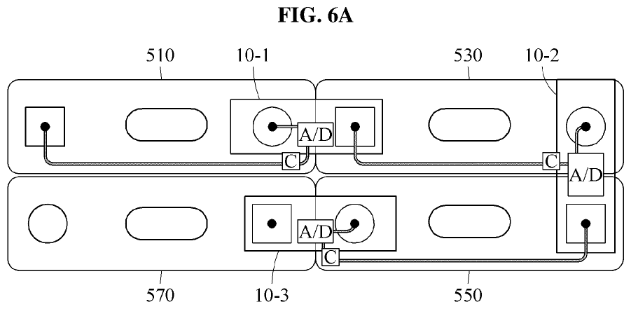

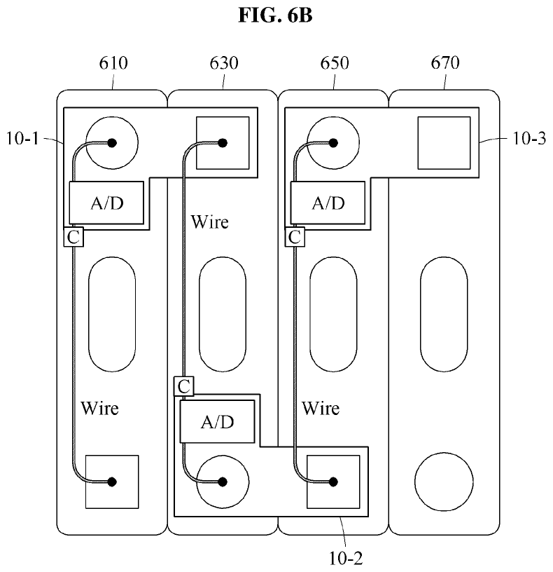

FIG. 6A illustrates an example of a view of connections between battery cells and bus bars (e.g., including the connection of FIG. 5).

Referring to FIG. 6A, battery cells 510, 530, 550, and 570 are connected to each other in series. The battery cells 510, 530, 550, and 570 are implemented in various shapes. For example, the battery cells 510, 530, 550, and 570 are implemented in the shape of square cells. The shapes of the battery cells 510, 530, 550, and 570 are not limited to the square cells, and the battery cells 510, 530, 550 may have various shapes.

As shown in the example of FIG. 6A, three bus bars 10-1, 10-2, and 10-3 connect the four battery cells in series. For example, the bus bar 10-1 connects the battery cell 510 and the battery cell 530, and the bus bar 10-2 connects the battery cell 530 and the battery cell 550. The bus bar 10-3 connects the battery cell 550 and the battery cell 570. Here, battery cells of adjacent rows are disposed to have opposite polarities.

The bus bars 10-1, 10-2, and 10-3 monitor the battery cells 510, 530, 550, and 570 being connected. The bus bars 10-1, 10-2, and 10-3 measure voltages applied between the battery cells 510, 530, 550, and 570 and temperatures of the battery cells 510, 530, 550, and 570, and exchange the measured information with an adjacent bus bar. For example, the bus bar 10-1 exchanges the measured information with either one or both of the bus bar 10-2 and the bus bar 10-3.

FIG. 6B illustrates an example of a view of connections between battery cells and bus bars (e.g., including the connection of FIG. 5).

Referring to FIG. 6B, battery cells 610, 630, 650, and 670 are connected to each other in series. The battery cells 610, 630, 650, and 670 are implemented in various shapes. For example, the battery cells 610, 630, 650, and 670 are implemented in the shape of square cells. The shapes of the battery cells 610, 630, 650, and 670 are not limited to the square cells, and the battery cells 610, 630, 650, and 670 may have various shapes.

As shown in the example of FIG. 6B, the four battery cells 610, 630, 650, and 670 are disposed alongside while changing polarities. In this example, the bus bars 10-1, 10-2, and 10-3 are disposed alternately on upper and lower sides of the battery cells 610, 630, 650, and 670.

That is, the bus bar 10-1 connects the battery cell 610 and the battery cell 630, the bus bar 10-2 connects the battery cell 630 and the battery cell 650, and the bus bar 10-3 connects the battery cell 650 and the battery cell 670.

The bus bars 10-1, 10-2, and 10-3 monitor the battery cells 610, 630, 650, and 670 being connected. The bus bars 10-1, 10-2, and 10-3 measure voltages applied between the battery cells 610, 630, 650, and 670 and temperatures of the battery cells 610, 630, 650, and 670, and exchange the measured information with an adjacent bus bar. For example, the bus bar 10-1 exchanges the measured information with either one or both of the bus bar 10-2 and the bus bar 10-3.

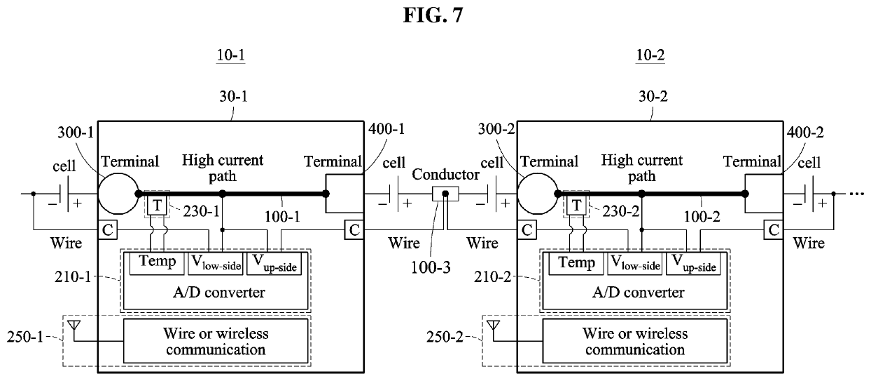

FIG. 7 illustrates an example of connections between battery cells and bus bars (e.g., including the bus bar 10 of FIG. 1).

Referring to FIG. 7, bus bara first bust-bar 10-1 and a second bus bar 10-2 are connected between all cells included in the battery pack or between only a portion of the cells. Each of bus bars 10-1 and 10-2 includes the conductor 100 and the controller 200.

The conductor 100-1 of the first bus bar 10-1 is connected to the two terminals 300-1 and 400-1, and the conductor 100-2 of the second bus bar 10-2 is connected to the two terminals 300-2 and 400-2. In this example, the terminal 300-1 is connected to the positive electrode of the first battery cell, and the terminal 400-1 is connected to the negative electrode of the second battery cell. Further, the terminal 300-2 is connected to the positive electrode of a third battery cell, and the terminal 400-2 is connected to the negative electrode of a fourth battery cell.

The circular terminal 300-1 connected to the left end of the conductor 100-1 is connected to a positive electrode of a battery cell, and the square terminal 400-1 connected to the right end of the conductor 100-1 is connected to a negative electrode of a battery cell. However, in another example, the terminals 300-1 and 400-1 may be connected reversely.

The first bus bar 10-1 includes the converter 210-1, the temperature sensor 230-1, and the communicator 250-1 on the substrate 30-1, and the second bus bar 10-2 includes the converter 210-2, the temperature sensor 230-2, and the communicator 250-2 on the substrate 30-2.

The converter 210-1 obtains information related to the conductor 100-1 or the battery cells by measuring a voltage applied to the conductor 100-1 and receiving a temperature of the conductor 100-1 through the temperature sensor 230-1. The information obtained by the converter 210-1 includes information related to the first battery cell and the second battery cell.

The converter 210-1 outputs the information related to the conductor 100-1 or the battery cells to the communicator 250-1. The communicator 250-1 exchanges the information with the communicator 250-2 of the second bus bar 10-2.

An operation of the second bus bar 10-2 is similar or the same as the operation of the first bus bar 10-1.

In addition, as shown in the example of FIG. 7, not all the battery cells are connected through the bus bar 10. For example, a single bus bar 10 is used for every two battery cells in order to connect the battery cells. In this example, cells not connected by the bus bar 10 are connected by a simple conductor 100-3. In this example, while the negative electrode of the second battery cell is connected to the terminal 400-1 of the first bus bar 10-1, the positive electrode of the second battery cell is connected to the simple conductor 100-3, and the negative electrode of the third battery cell is also connected to the simple conductor 100-3. Accordingly, the first and the second battery cells are connected by the first bus bar 10-1, the second and the third battery cells are connected by the simple conductor 100-3, and the third and the fourth battery cells are connected by the second bus bar 10-2.

In the example of FIG. 7, as explained above, a single bus bar 10 is used for every two battery cells. However, in another example, every three or more battery cells are connected by a single bus bar 10.

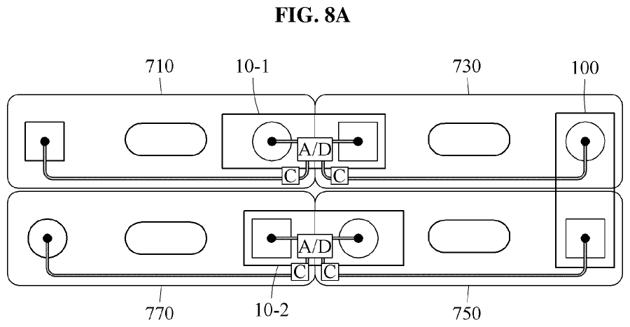

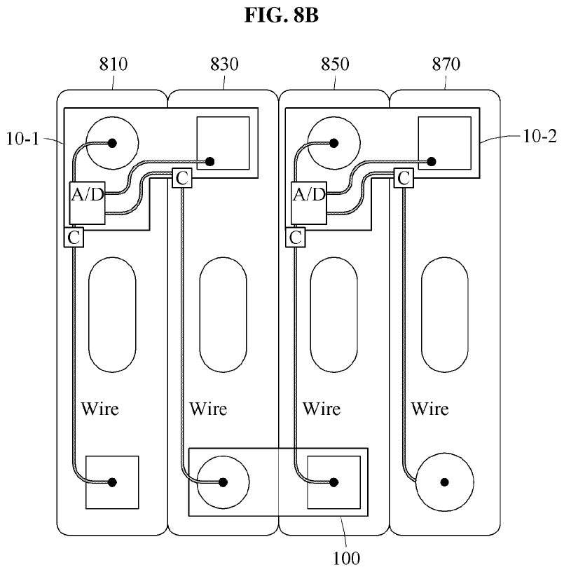

FIG. 8A illustrates an example of a view of connections between battery cells and bus bars (e.g., including the connection of FIG. 7).

Referring to FIG. 8A, battery cells 710, 730, 750, and 770 are connected to each other in series. The battery cells 710, 730, 750, and 770 are implemented in various shapes. For example, the battery cells 710, 730, 750, and 770 are implemented in the shape of square cells. The shapes of the battery cells 710, 730, 750, and 770 are not limited to the square cells, and the battery cells 710, 730, 750, and 770 may have various shapes.

As shown in the example of FIG. 8A, the four battery cells 710, 730, 750, and 770 are connected in series using two bus bars 10-1 and 10-2 and a single conductor 100. For example, the bus bar 10-1 connects the battery cell 710 and the battery cell 730. The bus bar 10-2 connects the battery cell 750 and the battery cell 770.

In this example, the battery cell 730 and the battery cell 750 are connected through the conductor 100. Here, battery cells of adjacent rows are disposed to have opposite polarities.

The bus bars 10-1 and 10-2 monitor the battery cells 710, 730, 750, and 770 being connected. The bus bars 10-1 and 10-2 measure voltages applied between the battery cells 710, 730, 750, and 770 and temperatures of the battery cells 710, 730, 750, and 770 and exchange the measured information with an adjacent bus bar. For example, the bus bar 10-1 exchanges the measured information with the bus bar 10-2.

FIG. 8B illustrates an example of a view of a connection between battery cells and a bus bar (e.g., including the connection of FIG. 7).

Referring to FIG. 8B, the battery cells 810, 830, 850, and 870 are connected to each other in series. The battery cells 810, 830, 850, and 870 are implemented in various shapes. For example, the battery cells 810, 830, 850, and 870 are implemented in the shape of square cells. The shapes of the battery cells 810, 830, 850, and 870 are not limited to the square cells, and the battery cells 810, 830, 850, and 870 may have various shapes.

As shown in the example of FIG. 8B, the four battery cells 810, 830, 850, and 870 are disposed alongside while changing polarities. In this example, the bus bar 10-1 is disposed on upper sides of the battery cells 810, 830, 850, and 870 to connect the battery cell 810 and the battery cell 830, and the bus bar 10-2 is disposed on upper sides of the battery cells 810, 830, 850, and 870 to connect the battery cell 850 and the battery cell 870.

Lower sides of the battery cells 810, 830, 850, and 870 are connected using only the conductor 100. That is, the battery cell 830 and the battery cell 850 are connected through the conductor 100.

The bus bars 10-1 and 10-2 monitor the battery cells 810, 830, 850, and 870 being connected. The bus bars 10-1 and 10-2 measure voltages applied between the battery cells 810, 830, 850, and 870 and temperatures of the battery cells 810, 830, 850, and 870 and exchange the measured information with an adjacent bus bar. For example, the bus bar 10-1 exchanges the measured information with the bus bar 10-2.

The bus bars, bus bars 10, 10-1, 10-2, 10-3, substrates 30, 30-1, 30-2, conductors 100, 100-1, 100-2, 100-3, controllers, controllers 200, 200-1, 200-2, converters 210, 210-1, 210-2, temperature sensors 230, 230-1, 230-2, communicators 250, 250-1, 250-2, MCUs 270, terminals 300, 300-1, 300-2, 400, 400-1, 400-2, battery cells, battery cells 510, 530, 550, 570, 610, 630, 650, 670, 710, 730, 750, 770, 810, 830, 850, 870, A/D converters, resistors, integrated circuits, condensers, and other apparatuses, units, modules, devices, and other components described herein with respect to FIGS. 1-8B are hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8B that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A bus bar apparatus, comprising:
a bus bar comprising:
a conductor configured to electrically connect battery cells included in a battery pack; and
a controller configured to manage the battery pack based on information obtained from the conductor,
wherein the conductor and the controller are implemented on a same substrate.

2. The apparatus of claim 1, wherein the conductor is configured to electrically connect a positive electrode of a first battery cell of the battery cells and a negative electrode of a second battery cell of the battery cells adjacent to the first battery cell.

3. The apparatus of claim 1, wherein the controller comprises a converter configured to measure a voltage applied to either one or both ends of the conductor.

4. The apparatus of claim 3, wherein the controller further comprises a temperature sensor configured to measure either one or both of a temperature of the conductor and temperatures of the battery cells.

5. The apparatus of claim 4, wherein the controller is configured to estimate a current of the battery pack based on the voltage and the either one or both of the temperature of the conductor and the temperatures of the battery cells.

6. The bus bar of claim 5, wherein the information indicates any one or any combination of any two or more of the estimated current, the measured voltage, and the either one or both of the temperature of the conductor and the temperatures of the battery cells.

7. The apparatus of claim 1, wherein the controller comprises a communicator configured to exchange the information with an adjacent bus bar.

8. The apparatus of claim 7, wherein the communicator is configured to exchange the information through either one or both of wired and wireless communication.

9. The apparatus of claim 7, wherein
the communicator is configured to exchange the information with the adjacent bus bar by transmitting the information to, and by receiving other information from, a communicator of the adjacent bus bar, and
the other information is information obtained from a conductor of the adjacent bus bar.

10. The apparatus of claim 1, wherein the substrate comprises a printed circuit board (PCB).

11. The apparatus of claim 1, wherein the controller is configured to manage the battery pack by determining either one or both of a state of charge and a state of health of one or more of the battery cells, based on either one or both of the information obtained from the conductor and information of one or more other battery cells received from an adjacent bus bar.

12. The apparatus of claim 1, wherein the bus bar apparatus is a battery management apparatus and further comprises another bus bar comprising:
another conductor configured to electrically connect battery cells included in the battery pack; and
another controller configured to manage the battery pack based on information obtained from the other conductor,
wherein the other conductor and the other controller are implemented on another same substrate.

13. A battery management apparatus, comprising:
a first bus bar and a second bus bar, each comprising:
a conductor configured to electrically connect battery cells included in a battery pack; and
a controller implemented on a substrate on which the conductor is disposed, the controller being configured to manage the battery pack based on information related to the battery cells obtained from the conductor.

14. The battery management apparatus of claim 13, wherein
the conductor of the first bus bar is configured to electrically connect a positive electrode of a first battery cell of the battery cells and a negative electrode of a second battery cell of the battery cell adjacent to the first battery cell, and
the conductor of the second bus bar is configured to electrically connect a positive electrode of the second battery cell and a negative electrode of a third battery cell of the battery cell adjacent to the second battery cell.

15. The battery management apparatus of claim 13, wherein the controller of the first bus bar and the controller of the second bus bar each comprise a converter configured to measure a voltage applied to either one or both ends of the respective conductor.

16. The battery management apparatus of claim 15, wherein the controller of the first bus bar and the controller of the second bus bar each further comprise a temperature sensor configured to measure either one or both of a temperature of the respective conductor and temperatures of the respective battery cells.

17. The battery management apparatus of claim 16, wherein the controller of the first bus bar and the controller of the second bus bar are each configured to estimate a current of the battery pack based on the voltage and the either one or both of the temperature of the respective conductor and the temperatures of the respective battery cells.

18. The battery management apparatus of claim 13, wherein
the controller of the first bus bar comprises a communicator configured to exchange the information of the first bus bar with the second bus bar, and
the controller of the second bus bar comprises a communicator configured to exchange the information of the second bus bar with the first bus bar.

19. The battery management apparatus of claim 18, wherein the communicator of the first bus bar and the communicator of the second bus bar are each configured to exchange the respective information of the first or the second bus bar through either one or both of wired and wireless communication.

20. The battery management apparatus of claim 13, wherein the substrate of either one or both of the first bus bar and the second bus bar comprises a printed circuit board (PCB).

21. A method of manufacturing a battery management apparatus, the method comprising:
forming a conductor on a substrate to electrically connect battery cells included in a battery pack; and
connecting a controller, to the conductor on the substrate, configured to manage the battery pack by obtaining information from the conductor.

22. The method of claim 21, wherein the connecting comprises:
connecting a converter of the controller to the conductor to measure a voltage applied to the conductor; and
connecting a temperature sensor of the controller to the conductor to measure either one or both of a temperature of the conductor and temperatures of the battery cells.

23. The method of claim 22, wherein the connecting of the controller to the conductor further comprises:
connecting a communicator of the controller to the converter to exchange the information with an adjacent bus bar through either one or both of wired and wireless communication.

24. The method of claim 21, further comprising:
connecting the conductor to the battery cells to electrically connect a positive electrode of a first battery cell of the battery cells and a negative electrode of a second battery cell of the battery cells adjacent to the first battery cell.
